(19) United States
(12) Patent Application Publication
(10) Pub. No.: US 2026/0182592 A1
(43) Pub. Date: Jul. 2, 2026

(54) MODULAR COMMERCIAL FOOD STORAGE, STERILIZATION, AND DRINKING WATER SUPPLY SYSTEM BASED ON MICROPLASMA ADVANCED OXIDATION PROCESS (AOP) AND ELECTROMAGNETIC SIGNALS (EMS) FOR DEVELOPING COUNTRIES

(71) Applicant: CAST CO.,LTD., Seoul (KR)

(72) Inventor: Min Hwan KIM, Seoul (KR)

(21) Appl. No.: 19/433,794

(22) Filed: Dec. 27, 2025

Related U.S. Application Data
(63) Continuation of application No. PCT/KR2024/021473, filed on Dec. 30, 2024.

(30) Foreign Application Priority Data
Dec. 30, 2024 (KR) 10-2024-0199595

(51) Int. Cl. A23B 2/704; A23B 2/00; C02F 1/78

(52) U.S. Cl. CPC A23B 2/7045; A23B 2/003; C02F 1/78

(57) ABSTRACT

Disclosed is a modular commercial food storage, sterilization, and drinking water supply system. The system comprises a food storage and drinking water supply apparatus, a user terminal, and an administrator terminal. The food storage and drinking water supply apparatus includes a solar power unit installed on an upper portion of the apparatus, an energy storage unit configured to store electric power, an ozone generation unit configured to receive power stored in the energy storage unit and generate ozone to be provided to a drinking water purification unit and a food processing management unit through an advanced oxidation process using microplasma, a food processing management unit configured to sterilize food using ozone generated from the ozone generation unit and deliver ozone into a food storage space, and a drinking water purification unit configured to purify drinking water by receiving ozone generated from the ozone generation unit.

### TECHNICAL FIELD

The present invention relates to a modular commercial food storage, sterilization, and drinking water supply system based on a microplasma advanced oxidation process (AOP) and electromagnetic signals (EMS) for developing countries, and in particular, the present invention relates to a system that provides a technology capable of simultaneously and efficiently solving food storage, food sterilization, and safe drinking water supply in developing countries suffering from energy shortage problems.

### BACKGROUND

Developing countries suffer simultaneously from food spoilage, water contamination, and energy shortages. Conventional food storage and sterilization technologies require expensive equipment and high energy consumption, making them unsuitable for use in such regions. In many developing countries, a lack of refrigeration and storage facilities, inefficiencies in food distribution processes, and poor storage environments result in frequent food spoilage. In particular, in tropical regions, high temperature and humidity accelerate the spoilage of fresh fruits, vegetables, and meat products, leading to significant food waste. Additionally, many developing countries face serious difficulties in securing clean drinking water due to water scarcity and contamination. Conventional water purification methods relying on chemical treatment generate environmentally harmful byproducts, and continuous operation of purification systems is difficult due to unstable power supplies. Moreover, traditional water purification systems require large-scale infrastructure, resulting in high installation and maintenance costs that are inefficient for small local communities. Consequently, many regions still lack access to hygienic drinking water, leading to the spread of infectious diseases.

Existing food storage and sterilization systems generally rely on expensive electronic devices or cooling systems, consume large amounts of energy, and incur high operating costs, making them impractical in developing countries. Chemical disinfectants and mechanical treatments may also pose environmental risks and long-term sustainability issues.

Large-scale water purification systems similarly require substantial infrastructure and maintenance costs. In developing countries, insufficient maintenance often results in incomplete purification, causing health problems. As a prior art, Korean Patent Registration No. 10-2557347 discloses a plasma-based agricultural product storage system that suppresses spoilage and ripening by generating ozone through plasma discharge and decomposing ethylene; however, it is limited to agricultural storage and does not address integrated food sterilization and drinking water supply in energy-deficient environments.

### SUMMARY

An object of the present invention is to provide a modular commercial food storage, sterilization, and drinking water supply system based on a microplasma advanced oxidation process (AOP) and electromagnetic signals (EMS) for developing countries, which enables simultaneous food storage, sterilization, and drinking water supply in regions with limited electrical power.

The system of the present invention minimizes power consumption by utilizing renewable energy such as solar power, extends food shelf life through microplasma-based AOP technology, and provides water purification functionality. In addition, electromagnetic signals (EMS) are used to maintain food quality and prevent water contamination. The present invention is particularly effective in hot and humid environments such as tropical climates and can be installed in small-scale local communities, thereby providing an economical and sustainable solution for developing countries without relying on chemical treatments or expensive equipment.

According to an embodiment of the present invention, a modular commercial food storage, sterilization, and drinking water supply system based on a microplasma advanced oxidation process (AOP) and electromagnetic signals (EMS) includes a food storage and drinking water supply apparatus, a user terminal, and an administrator terminal, wherein the food storage and drinking water supply apparatus includes a solar power unit installed on an upper portion of the apparatus, an energy storage unit configured to store electric power generated by the solar power unit or supplied from an external power source, an ozone generation unit configured to receive power from the energy storage unit and generate ozone for a drinking water purification unit and a food processing management unit through a microplasma-based advanced oxidation process, a food processing management unit configured to sterilize food using ozone generated by the ozone generation unit and deliver ozone into a food storage space, and a drinking water purification unit configured to purify water using ozone supplied from the ozone generation unit.

### Advantageous Effects

According to the present invention, food spoilage is suppressed and shelf life is extended through microplasma-based advanced oxidation processing and electromagnetic signal treatment, thereby maintaining food quality.

Furthermore, harmful bacteria and viruses are removed using microplasma-based water purification technology, providing safe drinking water.

In addition, reliance on external energy sources is minimized through solar power generation, ensuring available power even in emergency situations.

The system can also function as a food distribution hub, contributing to job creation and import substitution effects.

Moreover, chemical usage and carbon emissions are reduced, thereby minimizing environmental impact.

### BRIEF DESCRIPTION OF THE DRAWINGS

FIG. 1 is a configuration diagram illustrating a modular commercial food storage, sterilization, and drinking water supply system according to an embodiment of the present invention.

FIG. 2 is a diagram illustrating a food storage and drinking water supply apparatus according to an embodiment of the present invention.

FIG. 3 is a diagram illustrating a solar power unit according to an embodiment of the present invention.

FIG. 4 is a diagram illustrating a control method of the food storage and drinking water supply apparatus according to an embodiment of the present invention.

FIGS. 5A, 5B, 5C, 6A, 6B, 6C, 6D, 7A, 7B and 7C are exemplary diagrams illustrating water quality provided by the food storage and drinking water supply apparatus according to an embodiment of the present invention.

### DETAILED DESCRIPTION

With respect to the embodiments according to the concept of the present invention disclosed in the present specification, specific structural or functional descriptions are merely exemplified for the purpose of describing the embodiments according to the concept of the present invention, and the embodiments according to the concept of the present invention may be embodied in various forms and are not limited to the embodiments described in the present specification. Since the embodiments according to the concept of the present invention may have various modifications applied thereto and may have various forms, the embodiments are illustrated in the drawings and are intended to be described in detail in the present specification. However, this is not intended to limit the embodiments according to the concept of the present invention to specific disclosed forms, and includes all modifications, equivalents, or substitutes that fall within the spirit and technical scope of the present invention.

The terms used in the present specification are used only for the purpose of describing specific embodiments and are not intended to limit the present invention. Singular expressions include plural expressions unless the context clearly indicates otherwise. In the present specification, terms such as “include” or “have” are intended to specify the presence of stated features, numbers, steps, operations, components, parts, or combinations thereof, and should not be understood as precluding in advance the presence or addition of one or more other features, numbers, steps, operations, components, parts, or combinations thereof.

Hereinafter, embodiments of the present invention will be described in detail with reference to the accompanying drawings.

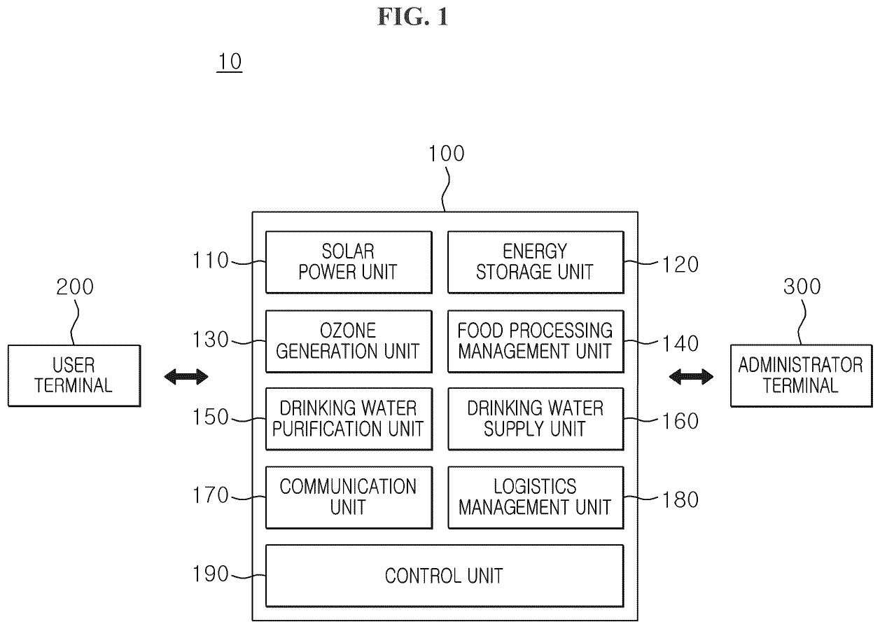

FIG. 1 is a configuration diagram illustrating a modular commercial food storage, sterilization, and drinking water supply system according to an embodiment of the present invention.

Referring to FIG. 1, a modular commercial food storage, sterilization, and drinking water supply system 10 is composed of a food storage and drinking water supply apparatus 100, a user terminal 200, and an administrator terminal 300.

The food storage and drinking water supply apparatus 100 is composed of a solar power unit 110, an energy storage unit 120, an ozone generation unit 130, a food processing management unit 140, a drinking water purification unit 150, a drinking water supply unit 160, a communication unit 170, a logistics management unit 180, and a control unit 190.

The solar power unit 110 is installed on an upper portion of the food storage and drinking water supply apparatus and may produce electrical energy. The solar power unit 110 is provided so as to be usable in developing countries where a power supply condition is not good, and is configured such that electricity produced by the solar power unit 110 is stored in the energy storage unit 120 so that power is stably supplied even in cloudy weather.

The energy storage unit 120 includes a charging means such as a supercapacitor, and the supercapacitor, unlike a conventional secondary battery, has a very fast charging speed, high efficiency, and has no risk of explosion because an electricity generation principle is physical charge storage. In addition, the supercapacitor, unlike a secondary battery in which a voltage pulls a current to charge, is charged in a manner in which a current pushes a voltage, and thus charging is possible even with a micro-current, so that charging is possible even on rainy days. For this reason, it is not necessary to calculate a margin for the number of cloudy days, and it is not necessary to install a solar panel with a capacity larger than a required capacity or to increase a battery capacity. In addition, the supercapacitor has a long lifespan, such as 20,000 or more charge/discharge cycles and an expected life of 10 years or more, and is less affected by environment and can be used even in an environment of −40° C. to +80° C., and thus can be used in various fields such as hot and humid Southeast Asia, a dry desert region with high temperature, and a region having severe cold. The energy storage unit 120 may store external power according to an embodiment.

The ozone generation unit 130 may generate ozone provided to the drinking water purification unit and the food processing management unit by receiving power stored in the energy storage unit and performing an advanced oxidation process using microplasma. The ozone generation unit 130 may efficiently generate ozone by combining a microplasma-based advanced oxidation process (AOP) method and an electromagnetic signal (EMS). The microplasma technology uses an electrical discharge phenomenon to decompose oxygen molecules (O₂) in air and thereby generate high-concentration ozone (O₃). Microplasma discharge does not cause a high-temperature, high-pressure state and has an advantage in that ozone can be stably generated with low power consumption. Microplasma discharge causes an interaction with oxygen (O₂) molecules in air by using high-frequency electromagnetic waves, and induces oxygen molecules to be converted into unstable ozone molecules. Ozone generated in this process decomposes harmful substances in water with high oxidizing power and performs sterilization and water purification functions of food and drinking water. In addition, EMS (electromagnetic signal) plays an important role in increasing ozone generation efficiency and increasing stability of generated ozone. EMS induces activation of ozone molecules through electromagnetic waves, thereby maximizing oxidizing power of ozone. Through this, generated ozone effectively removes bacteria, viruses, and other microorganisms in drinking water and within a food storage space, and in combination with the advanced oxidation process (AOP) method exhibits a stronger and continuous sterilization effect. Accordingly, the ozone generation unit 130 can efficiently generate ozone using microplasma and EMS technologies, and through this, can improve quality of food and drinking water and provide a core technical element for safe storage and supply.

The ozone generation unit 130 includes a circular first floating electrode having an air inlet installed to be connected to an external air supply line, a second floating electrode coupled to the first floating electrode and having an ozone outlet installed to be connected to an ozone discharge line, a high-voltage conductor disposed between the first floating electrode and the second floating electrode and generating plasma on a plurality of micro-patterns, a first dielectric disposed between the first floating electrode and the high-voltage conductor, and a second dielectric disposed between the high-voltage conductor and the second floating electrode. In an ozone generation unit configured as described above, when air flows in through the air inlet of the first floating electrode, the air moves from a center of an upper surface of the high-voltage conductor toward a side of the upper surface, and the moved air moves from a side of a lower surface toward a center of the lower surface and is discharged through the ozone outlet of the second floating electrode. At this time, plasma is generated in the micro-patterns of the high-voltage conductor, and ozone is generated by reacting with the introduced air. The ozone generated as described above is discharged together with the air through the ozone outlet of the second floating electrode.

The food processing management unit 140 may sterilize food by using ozone generated from the ozone generation unit and may deliver ozone into a food storage space. The food processing management unit 140 includes a plurality of sensors to detect a current state inside the food storage and drinking water supply apparatus 100, and by analyzing a detection result and controlling a circulation unit 400 so as to satisfy preset conditions, may supply generated ozone at a concentration suitable for each stored agricultural product. In the food processing management unit 140, a sterilization technology using ozone may be used to remove microorganisms, bacteria, viruses, and the like that may exist in food. Ozone can effectively remove microorganisms existing on a food surface by using strong oxidizing power, and this process can increase food safety because a chemical residue is not left. Since ozone concentration and treatment time should be adjusted depending on type of food and purpose of treatment, the food processing management unit 140 has a system that precisely controls ozone concentration suitable for various foods. If ozone concentration is too high, it may affect food, and if it is too low, a sterilization effect may decrease. The food processing management unit 140 can continuously monitor food quality in an ozone treatment process, and quality management items include color, odor, taste, texture, and the like, and an optimal treatment condition can be found by tracking how these change after ozone treatment. The food processing management unit 140 can automate an ozone treatment process to improve processing speed and consistency, and through an automation system, ozone concentration, treatment time, and customized treatment according to food type are performed, and through this, more efficient and consistent quality can be maintained.

The drinking water purification unit 150 may purify drinking water by receiving ozone generated from the ozone generation unit. The drinking water purification unit 150 may sterilize raw water by using high-concentration ozone generated in the ozone generation unit 130 and may purify it into safe and clean drinking water. The drinking water purification unit 150 applies an advanced oxidation process (AOP) method that removes harmful microorganisms, viruses, bacteria, and other organic substances in water by effectively using ozone. The drinking water purification unit 150 operates by injecting ozone generated from the ozone generation unit 130 into raw water, and decomposes pathogenic microorganisms and harmful substances in raw water by using strong oxidizing power of ozone. Ozone is a material having excellent sterilization efficacy, and when contacting viruses or bacteria in water, quickly oxidizes them to remove harmful bacteria. In addition, ozone combines with chlorine or organic substances in water to improve taste and odor of water, and is also effective in solving a residual chlorine problem. The drinking water purification unit 150 includes a control module that precisely controls ozone concentration and injection time to minimize unnecessary byproducts that may occur in a process of generating ozone, and this control module optimizes an ozone injection amount according to ozone concentration and contamination degree of raw water, thereby maximizing efficiency of a purification process and minimizing energy consumption by using only a necessary amount of ozone. The drinking water purification unit 150 may be designed to dispose a plurality of ozone injection ports in a purifier or to have a structure capable of dispersing ozone at a constant concentration so that ozone uniformly acts on entire water, thereby exhibiting a fast and uniform sterilization effect, and water after purification maintains safe and drinkable quality. As a result, the drinking water purification unit 150 efficiently uses ozone generated from the ozone generation unit 130 to sterilize raw water and remove harmful substances, and provides cleaner and safer drinking water through the advanced oxidation process (AOP) method.

The drinking water supply unit 160 may provide purified drinking water from the drinking water purification unit in response to a request from the user terminal. The drinking water supply unit 160 may provide water each time a necessary user requests it through the user terminal. The present invention includes a module that, in association with the user terminal, provides drinking water efficiently and accurately according to a user's request in addition to water purification. Water purified in the drinking water purification unit 150 is highly purified and is provided to a user in a safe and clean state. This water is treated into a usable state after being sterilized using ozone generated from the ozone generation unit 130 and then undergoing an additional purification process in the drinking water purification unit 150. The treated water is stored at a constant pressure and temperature and is supplied in an appropriate amount and temperature according to a user's request. The user terminal is a key device controlling water supply and is a device through which a user can call drinking water when drinking water is needed. The user terminal is connected with a mobile device, a smartphone application, or a fixed touch screen device, and through this, a user can set an amount, temperature, and supply time of water in real time. In addition, the user terminal provides maintenance information such as filter replacement or system state inspection so that a user can determine whether the system operates normally. The drinking water supply unit 160 operates automatically according to a user request, and continuously monitors a state and quality of purified water even while providing water, thereby preventing water including contaminants from being supplied and accurately providing the requested amount of water. In addition, through real-time communication between the drinking water purification unit 150 and the user terminal, a user can check remaining water amount, quality of provided water, supply time, and the like, and can update ozone concentration and purification conditions in real time if necessary.

The communication unit 170 enables real-time communication between the user terminal and the administrator terminal. The communication unit 170 can transmit and receive data through a wired or wireless network, and supports two-way communication to enable real-time information delivery and monitoring between terminals. The user terminal 200 is a main device that delivers water supply, state confirmation, request items, and the like, and is directly connected with a user. The communication unit 170 receives a request from the user terminal and controls a system that provides drinking water in association with the drinking water purification unit 150 by processing the request. In addition, the user terminal is provided so as to allow real-time checking of information on water supply status, quantity, temperature, quality, and the like. Request items generated in the user terminal are immediately processed through the communication unit 170, and system state is updated in real time so that feedback is provided to the user. For example, when a user requests a specific amount of water or tries to adjust water temperature, the communication unit recognizes and quickly processes the request and provides a customized service to the user.

The administrator terminal 300 is a device in charge of overall management and monitoring of the system, and is connected with the communication unit 170 to collect real-time information on a system state. The administrator terminal mainly performs roles such as system maintenance, abnormal state monitoring, filter state checking, repair and inspection item processing. The administrator terminal receives, in real time through the communication unit 170, information such as state of each drinking water purification system, quality of purified water, ozone concentration, and the like, and based on this, takes an appropriate measure if necessary. In addition, when a problem occurs in the system or an unexpected situation occurs, a warning notification is automatically transmitted to the administrator so that a quick response is possible.

The communication unit 170 supports two-way data transmission to promote real-time interaction between the user and the administrator. The communication unit 170 quickly processes user requests, state changes, inspection items, and the like, and transmits all necessary data to the administrator terminal in real time. The administrator terminal collects and analyzes data and makes a decision for system optimization.

The communication unit 170 is an important element in all data transmission processes, and protects personal information and system data through encrypted data transmission. User requests and system state information are safely processed, and communication with the administrator terminal is managed such that only an authorized user can access through an authentication procedure. According to an embodiment, the communication unit 170 may be designed based on a cloud, and through this, information sharing and real-time monitoring between the user terminal and the administrator terminal become easier.

The logistics management unit 180 generates logistics information including types of food stored in the food processing management unit, storage periods, and the like, and if requested for logistics information by the administrator terminal, can provide the logistics information.

The logistics management unit 180 also manages drinking water and stored vegetables and other agricultural products. In the case of agricultural products, since quality can rapidly change in a storage and supply process, it is very important to efficiently manage them and maintain an optimal state. The logistics management unit 180 predicts demand for agricultural products and performs a role of accurately supplying fresh vegetables to a user as much as needed. In response to a request from the user terminal, the logistics management unit 180 manages a route and adjusts a supply amount so that optimal agricultural products can be quickly supplied. In addition, agricultural products are managed to be consumed in a predetermined order, and through this, agricultural products are supplied to the user in a fresh state. For example, agricultural products having a close expiration date are supplied preferentially to minimize waste and maintain quality.

The logistics management unit 180 tracks an inventory state of agricultural products in real time and appropriately adjusts inventory according to demand. The logistics management unit 180 analyzes consumption patterns of agricultural products using a prediction model and plans to secure necessary inventory in a timely manner. In addition, the logistics management unit 180 predicts supply by considering seasonal demand or demand changes according to a specific event and establishes a supply and demand plan of agricultural products based on this. For example, if it is expected that consumption of vegetables will increase sharply in summer, a sufficient amount is stored in advance and a supply imbalance is resolved by optimizing a supply route.

The logistics management unit 180 supports fast and efficient supply by optimizing a delivery route and a distribution process of agricultural products. Since agricultural products should be delivered to a user within a fast time in order to maintain freshness, delay in a delivery process is minimized and the route is efficiently adjusted. A vehicle for delivery or a movement route is managed in real time, and if necessary, delivery is performed through an automated system. For example, an optimal logistics route is automatically set such that agricultural products requested by a user can depart from a nearby storage.

The logistics management unit 180 prepares a system capable of continuously securing fresh agricultural products through cooperation with growers supplying agricultural products. In order to improve quality of agricultural products, the logistics management unit 180 guarantees quality of agricultural products through cooperation with growers and adjusts supply according to a growing situation. A system managing a supply network tracks production capability and supply state of growers in real time, and adjusts supply of agricultural products as needed to maintain balance.

The control unit 190 is configured to control all components of the present invention, and analyzes whether a detection result of an food processing management unit 140 and a current state of an internal storage space of a food storage and drinking water supply apparatus 100 satisfy preset conditions. For example, when it is assumed that an optimal ozone concentration for sterilizing agricultural products stored in the storage space of the food storage and drinking water supply apparatus 100 is 10 as preset data, if the detected ozone concentration in the storage space of the food storage and drinking water supply apparatus 100 is 7, a control unit 190 opens a first on-off valve 4100, closes a second on-off valve 420, and forward-rotates a circulation fan 430 to supply ozone generated by a ozone generation unit 130 into the storage space of the food storage and drinking water supply apparatus 100. If the detected ozone concentration in the storage space of the food storage and drinking water supply apparatus 100 is 12, the control unit 190 closes the first on-off valve 410, opens the second on-off valve 420, and reverse-rotates the circulation fan 430 to discharge ozone in the storage space of the food storage and drinking water supply apparatus 100 to the outside of the food storage and drinking water supply apparatus 100. In the present embodiment, a case where the food processing management unit 140 detects ozone has been described, but even when the food processing management unit 140 detects temperature, humidity, carbon dioxide concentration, and ethylene concentration, the control unit 190 is operated by the above-described mechanism. In the case of temperature, the control unit 190 controls a heat exchanger (not shown) installed in the internal storage space of the food storage and drinking water supply apparatus 100, in the case of humidity, the control unit 190 controls a humidity controller (not shown) installed in the internal storage space of the food storage and drinking water supply apparatus 100, and when carbon dioxide concentration and ethylene concentration are detected to be higher than preset conditions, the control unit 190 operates in the same manner as discharging ozone in the storage space to lower carbon dioxide concentration and ethylene concentration in the storage space.

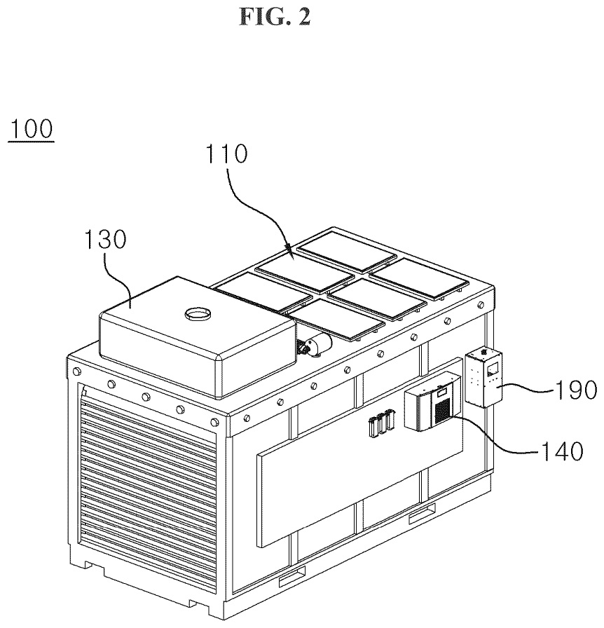

FIG. 2 is a diagram illustrating a food storage and drinking water supply apparatus according to an embodiment of the present invention.

Referring to FIG. 2, the food storage and drinking water supply apparatus 100 includes a solar power unit 110 provided on an upper portion thereof, and an ozone generation unit 130 provided on one side of the solar power unit 110. The food processing management unit 140 and the control unit 190 may be provided on a side surface of the food storage and drinking water supply apparatus 100. The food storage and drinking water supply apparatus 100 may include an internal space in which drinking water is stored, or an internal space in which agricultural products are stored and preserved.

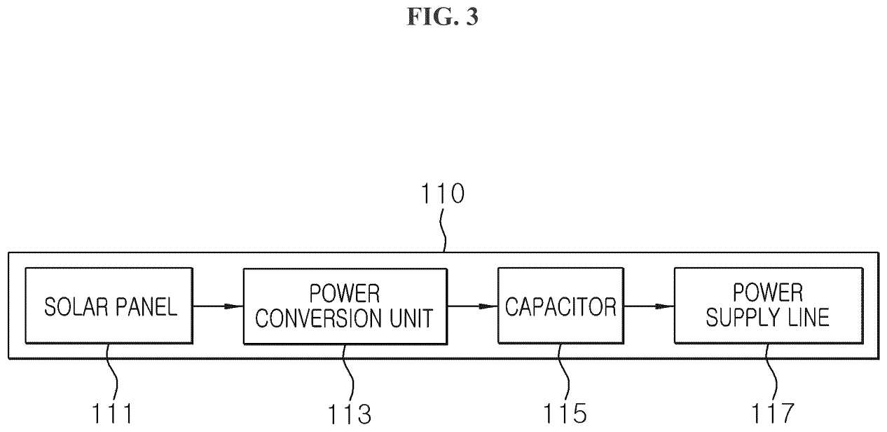

FIG. 3 is a diagram illustrating a solar power unit according to an embodiment of the present invention.

Referring to FIG. 3, the solar power unit 110 includes a solar panel 111 installed on an upper portion of the food storage and drinking water supply apparatus 100, a power conversion unit 113 configured to convert electric power generated by the solar panel 111, a capacitor 115 configured to store electric power converted by the power conversion unit 113, and a power supply line configured to supply power by interconnecting the capacitor 115 with the ozone generation unit 130, the food processing management unit 140, and the control unit 190. The solar panel 111 is a panel that performs power generation through general solar light and is fixedly installed on an upper portion of the food storage and drinking water supply apparatus 100 through a separate mounting structure. Solar energy is converted into electric power through the solar panel 111, and the converted electric power is converted into electric power usable for the present invention, for example alternating current power, through the power conversion unit 113. The electric power converted by the power conversion unit 113 is stored in the capacitor 115, and the electric power stored in the capacitor 115 is supplied through the power supply line to the ozone generation unit and other components so as to enable operation. In addition, the electric power is transmitted to the energy storage unit 120 to store electric power.

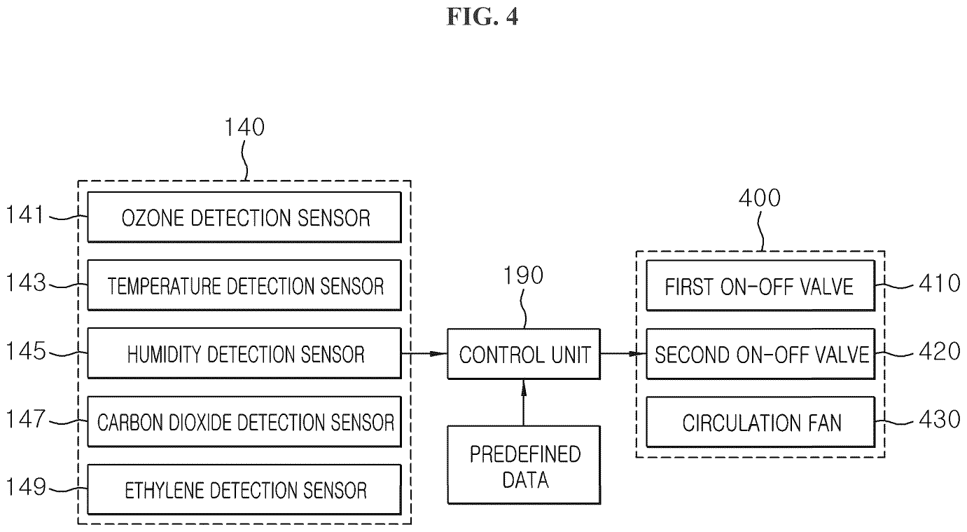

FIG. 4 is a diagram illustrating a control method of a food storage and drinking water supply apparatus according to an embodiment of the present invention.

Referring to FIG. 4, the food processing management unit 140 includes an ozone detection sensor 141, a temperature detection sensor 143, a humidity detection sensor 145, a carbon dioxide detection sensor 147, and an ethylene detection sensor 149, and detects ozone concentration, temperature, humidity, carbon dioxide concentration, and ethylene concentration inside an internal storage space of the food storage and drinking water supply apparatus 100. The food processing management unit 140 may further include various sensors according to user needs. The food processing management unit 140 detects ozone concentration, temperature, humidity, carbon dioxide concentration, and ethylene concentration inside the internal storage space of the food storage and drinking water supply apparatus 100 and transmits detected values to the control unit 190.

A circulation unit 400 includes a first on-off valve 410 installed in an ozone supply line to open or close the ozone supply line, a second on-off valve 420 installed in an ozone discharge line to open or close the ozone discharge line, and a circulation fan 430 installed in the ozone supply line. The ozone supply line is a pipe having a predetermined diameter with a transfer space formed therein, one side of which is installed to be connected to an ozone discharge line of the ozone generation unit 130 and the other side of which is installed to extend into the internal storage space of the food storage and drinking water supply apparatus 100, thereby supplying ozone generated by the ozone generation unit 140 through the ozone discharge line into the internal storage space. The ozone discharge line is a pipe having a predetermined diameter with a transfer space formed therein, one side of which is installed to be connected to an intermediate region of the ozone supply line. That is, the ozone discharge line is installed to have a branched form from the intermediate region of the ozone supply line. The other side of the ozone discharge line is formed to protrude to the outside of the food storage and drinking water supply apparatus 100 so as to connect the outside of the food storage and drinking water supply apparatus 100 through the ozone supply line.

The first on-off valve 410 is formed such that an opening and closing plate corresponding to an internal transfer space of the ozone supply line is rotatably formed inside the ozone supply line, and opens or closes the internal transfer space of the ozone supply line by rotation of the opening and closing plate. In addition, the second on-off valve 420 is formed such that an opening and closing plate corresponding to an internal transfer space of the ozone discharge line is rotatably formed inside the ozone discharge line, and opens or closes the internal transfer space of the ozone discharge line by rotation of the opening and closing plate. In the embodiment of the present invention, the first on-off valve 410 and the second on-off valve 420 are described as opening and closing plates rotatably installed inside the ozone supply line and the ozone discharge line, but the present invention is not limited thereto, and includes various types of valves capable of opening or closing the ozone supply line and the ozone discharge line.

The circulation fan 430 is generally provided as a fan capable of circulating air and is installed inside the ozone supply line. When the circulation fan 430 rotates in a forward direction, ozone generated by the ozone generation unit 140 and air outside the food storage and drinking water supply apparatus 100 are supplied into the internal storage space of the food storage and drinking water supply apparatus 100 through the ozone supply line 310. At this time, the first on-off valve 410 is maintained in an open state and the second on-off valve 420 is maintained in a closed state. In addition, when the circulation fan 430 rotates in a reverse direction, ozone present in the internal storage space of the food storage and drinking water supply apparatus 100 and air inside the storage space are discharged to the outside through the ozone discharge line. At this time, the first on-off valve 410 is maintained in a closed state and the second on-off valve 420 is maintained in an open state.

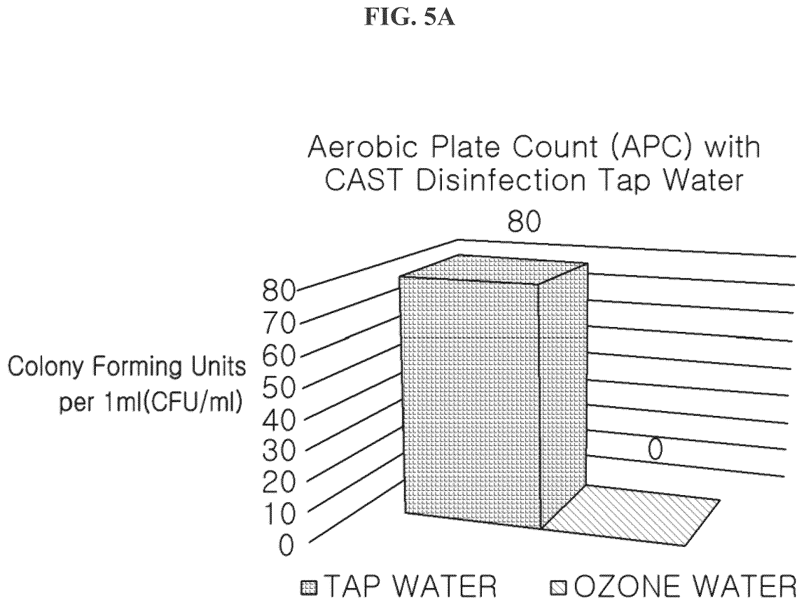

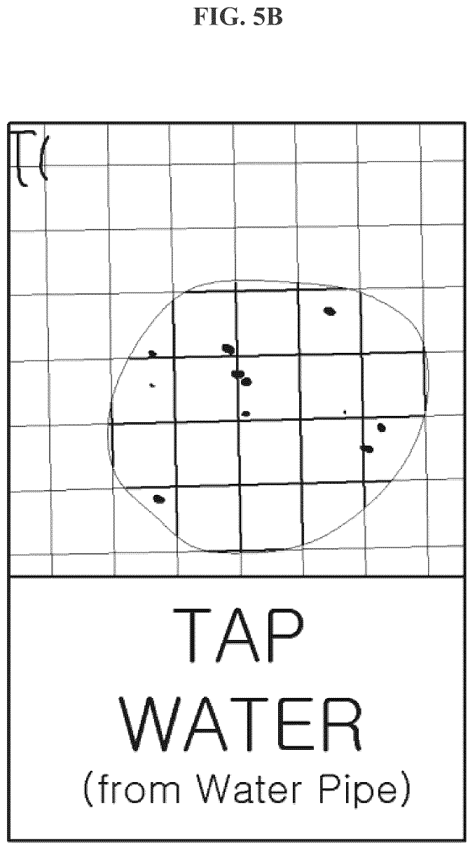

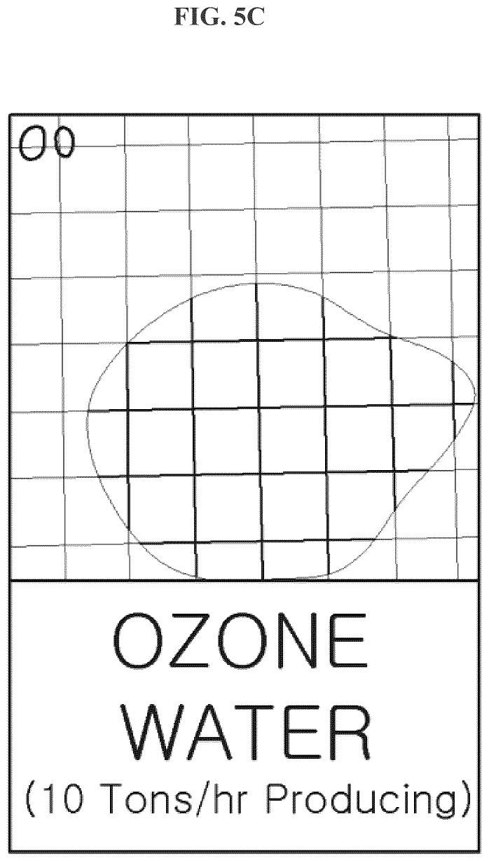

FIG. 5 is an exemplary diagram illustrating the quality of drinking water provided by the food storage and drinking water supply apparatus according to an embodiment of the present invention. Referring to FIG. 5, in order to test the quality of raw water to be supplied, a microbial sample of the raw water was collected, inoculated onto a standard culture medium, and cultured for a predetermined period of time, after which the numbers of bacterial and fungal colonies were counted. Through this process, changes in the number of microorganisms and reduction effects before ozone water treatment were evaluated in comparison with general tap water. The experimental results were expressed as average values, and microbial reduction rates of each group were compared. As a result of the water quality test of the supplied raw water, microorganisms were detected in the raw water, whereas in the case of ozone-treated water, no microorganisms were detected. Through this, a sterilization rate of 99.99% was confirmed.

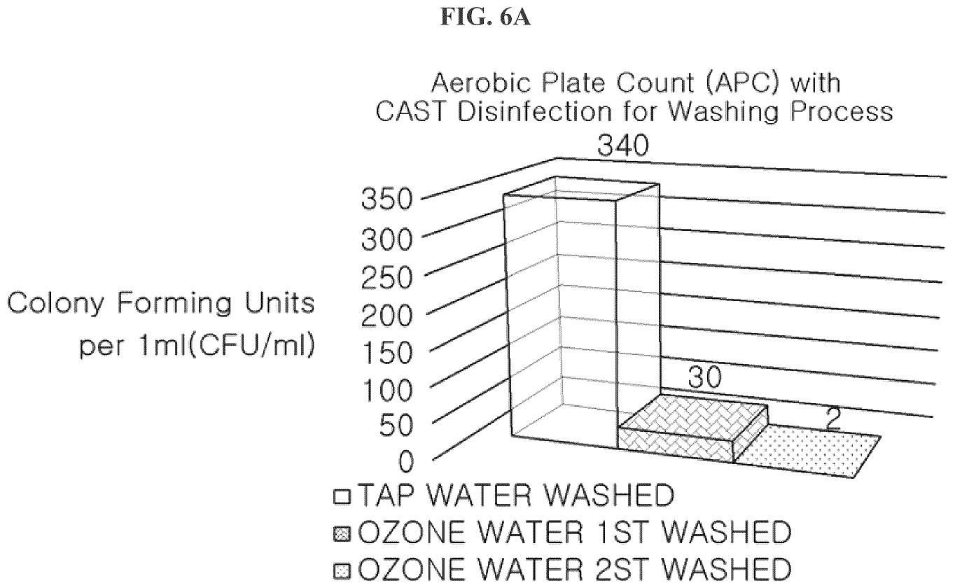

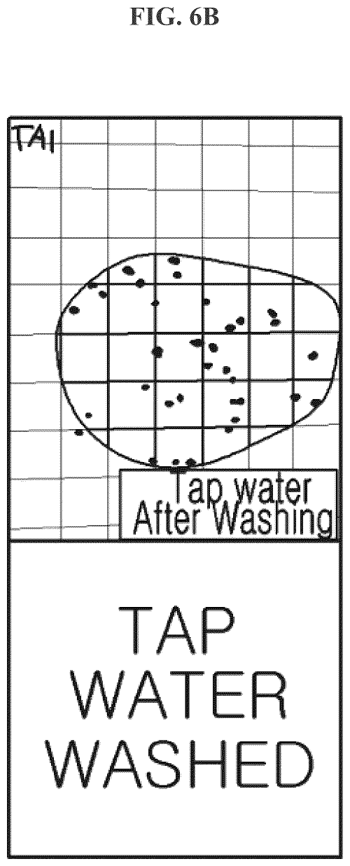

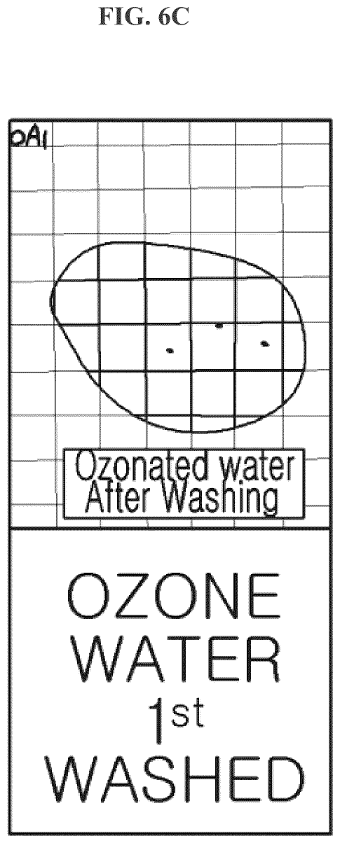

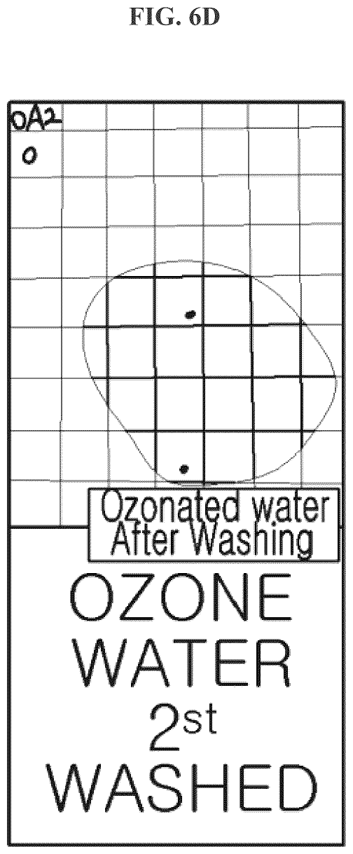

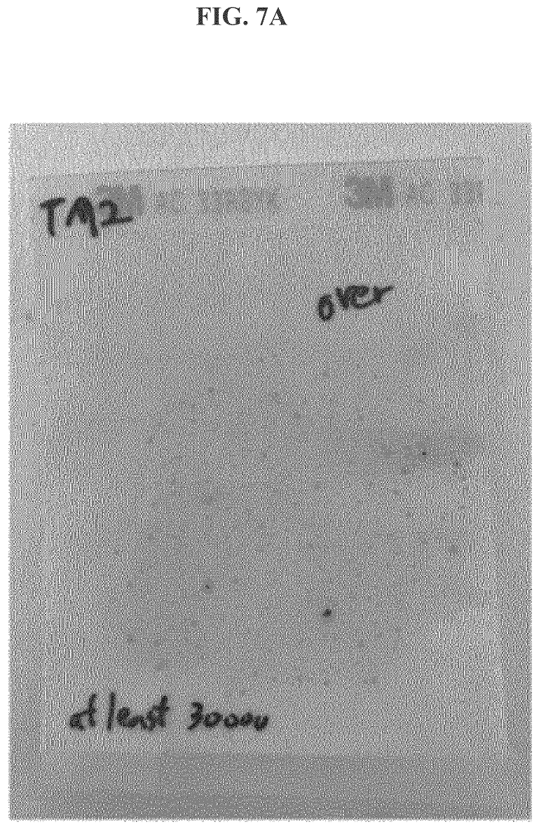

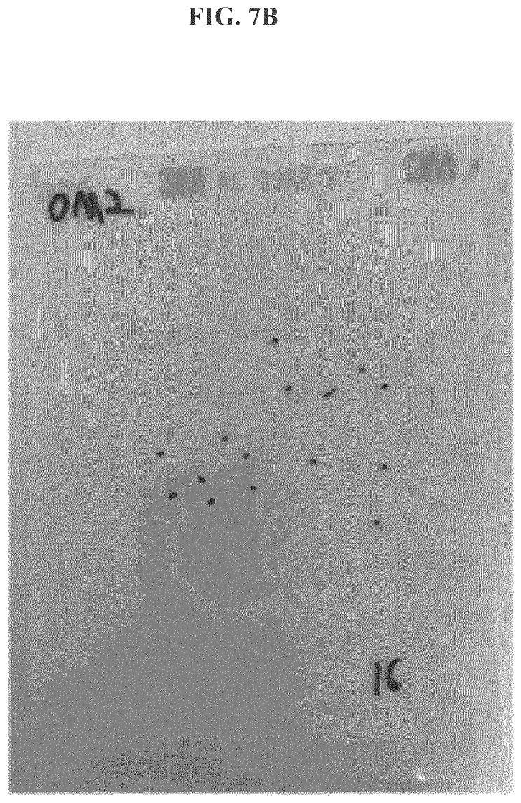

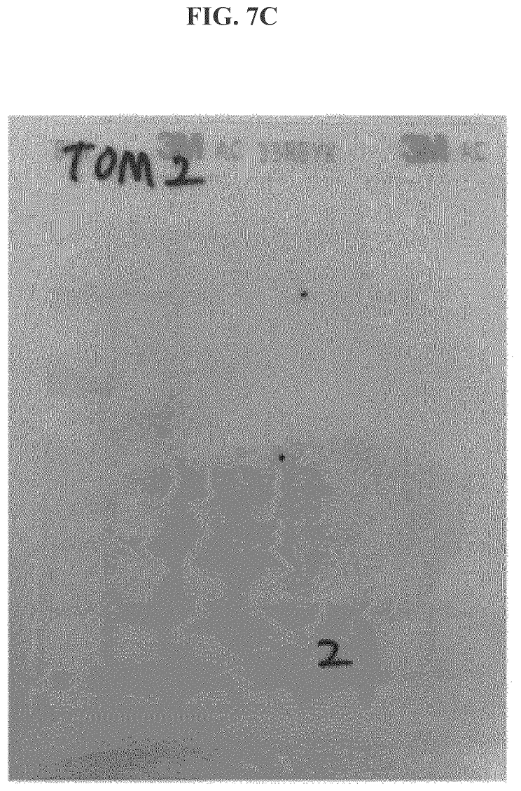

FIG. 6 and FIG. 7 are exemplary diagrams illustrating the quality of drinking water provided by the food storage and drinking water supply apparatus according to an embodiment of the present invention. Referring to FIGS. 6 and 7, in order to measure the amount of microorganisms present on surfaces of avocados and mangoes, microbial samples were collected from washing water after washing the agricultural products. The collected samples were inoculated onto a standard culture medium and cultured for a predetermined period of time, after which the numbers of bacterial and fungal colonies were counted. Through this process, changes in the number of microorganisms and reduction effects after treatment with general tap water and ozone-treated water were evaluated. The experimental results were expressed as average values, and microbial reduction rates of each group were compared. As a result of the washing experiment, the bacterial counts when washed with raw water (FIG. 6A), when washed once with ozone-treated water (FIG. 6B), and when washed twice with ozone-treated water (FIG. 6C) are as shown in the drawings.

Referring to FIG. 7, in a comparative experiment of general bacterial counts on mangoes, when the mangoes were immersed in tap water for five minutes (FIG. 7A), the bacterial count was at least 30,000 CFU/1 ml, whereas when the mangoes were immersed in ozone-treated water for five minutes (FIG. 7B), the bacterial count was reduced to 1,600 CFU/1 ml, corresponding to a reduction of approximately 95%. Further, when the mangoes were immersed in ozone-treated water twice for five minutes (FIG. 7C), the bacterial count was reduced to 200 CFU/1 ml, corresponding to a reduction of approximately 99.4%.

The disclosure has been described with reference to the embodiments illustrated in the drawings, but these are merely exemplary, and those skilled in the art will understand that various modifications and equivalent other embodiments are possible from this. Accordingly, the true technical protection scope of the present disclosure should be determined by the technical idea of the attached registration claims.

[Detailed Description of Main Elements]

| | |
|---|---|
| 100: Food storage and drinking | |
| water supply apparatus | |
| 110: Solar power unit | 120: Energy storage unit |
| 130: Ozone generation unit | 140: Food processing management unit |
| 150: Drinking water purification | 160: Drinking water supply unit |
| unit | |
| 170: Communication unit | 180: Logistics management unit |
| 190: Control unit | 200: User terminal |
| 300: Administrator terminal | 400: Circulation unit |

What is claimed is:

1. A modular commercial food storage, sterilization, and drinking water supply system based on a microplasma advanced oxidation process (AOP) and electromagnetic signals (EMS), wherein the system comprises a food storage and drinking water supply apparatus, a user terminal, and an administrator terminal,
wherein the food storage and drinking water supply apparatus comprises
a solar power unit installed on an upper portion of the food storage and drinking water supply apparatus;
an energy storage unit in which electric power generated by the solar power unit or external power is stored;
an ozone generation unit configured to receive power stored in the energy storage unit and generate ozone to be provided to a drinking water purification unit and a food processing management unit through an advanced oxidation process using microplasma;
a food processing management unit configured to sterilize food using ozone generated from the ozone generation unit and deliver ozone into a food storage space; and
a drinking water purification unit configured to purify drinking water by receiving ozone generated from the ozone generation unit.

2. The modular commercial food storage, sterilization, and drinking water supply system of claim 1,
further comprising a drinking water supply unit configured to supply drinking water purified by the drinking water purification unit in response to a request from the user terminal; and
a logistics management unit configured to generate logistics information including types of food stored in the food processing management unit and storage periods and to provide the logistics information when requested by the administrator terminal.

3. The modular commercial food storage, sterilization, and drinking water supply system of claim 2,
wherein the ozone generation unit comprises
a first floating electrode having a circular shape and including an air inlet installed to be connected to an external air supply line,
a second floating electrode coupled to the first floating electrode and including an ozone outlet installed to be connected to an ozone discharge line,
a high-voltage conductor disposed between the first floating electrode and the second floating electrode and configured to generate plasma on a plurality of micro-patterns,
a first dielectric disposed between the first floating electrode and the high-voltage conductor, and
a second dielectric disposed between the high-voltage conductor and the second floating electrode.

4. The modular commercial food storage, sterilization, and drinking water supply system of claim 3,
wherein the food processing management unit includes a plurality of sensors configured to detect a current state inside the food storage and drinking water supply apparatus and analyzes detection results to control a circulation unit so as to satisfy preset conditions, thereby supplying generated ozone at a concentration suitable for each stored agricultural product.

5. The modular commercial food storage, sterilization, and drinking water supply system of claim 4,
wherein the circulation unit comprises
a first on-off valve installed inside an ozone supply line to open or close the ozone supply line,
a second on-off valve installed inside an ozone discharge line to open or close the ozone discharge line, and
a circulation fan installed inside the ozone supply line.
